(19) United States
(12) Patent Application Publication
(10) Pub. No.: US 2013/0309447 A1
(43) Pub. Date: Nov. 21, 2013

(54) LAMINATION PLATE ASSEMBLY

(71) Applicant: Thomas Ziemkus, Harleysville, PA (US)

(72) Inventor: Thomas Ziemkus, Harleysville, PA (US)

(21) Appl. No.: 13/897,497

(22) Filed: May 20, 2013

Related U.S. Application Data
(60) Provisional application No. 61/649,479, filed on May 21, 2012.

(51) Int. Cl. G02B 3/00; B32B 3/26; B32B 3/30

(52) U.S. Cl. CPC G02B 3/00; B32B 3/30; B32B 3/266
USPC 428/137; 428/172; 428/167

(57) ABSTRACT

A lamination plate assembly for use in the manufacture of plastic lenticular cards includes a front lamination plate with first and second opposing planar surfaces. The front lamination plate is shaped to define a plurality of transverse bores that are arranged in a grid. Each bore in the front lamination plate is dimensioned to fittingly receive a corresponding, disc-shaped metal insert in a flush relationship relative thereto, with each insert preferably retained within its associated bore using an appropriate bonding agent. The lamination plate assembly additionally includes a bore-free, back lamination plate with first and second opposing planar surfaces, the back lamination plate being stacked front-to-back against the front lamination plate. The exposed surface of each insert includes a lenticular lens structure, such as an array of parallel, semi-cylindrical grooves or notches, which together create a corresponding lenticular lens structure in a multilayered plastic card sheet produced during lamination.

### FIELD OF THE INVENTION

The present invention relates generally to the manufacture of plastic cards and more particularly to the manufacture of plastic cards that include a lenticular device.

### BACKGROUND OF THE INVENTION

Plastic cards are well known in the art and are commonly constructed for use as, inter alia, financial cards (e.g., credit cards, debit cards and the like), commercial cards (e.g., gift cards, membership cards, loyalty cards, phone cards and the like), identification cards (e.g., drivers licenses and the like), and security cards (e.g., key cards, access cards and the like).

For aesthetic and/or security purposes, plastic cards are commonly provided with a lenticular device (also referred to herein as a lenticular element). A lenticular device relies upon a form of printing technology in which a lenticular lens is integrated into the card structure and is used to produce either (i) an image with offset layers that together produce a 3D effect and/or (ii) multiple images, each of which is viewable from a particular angle that together can be used to create a particular effect (e.g., a motion, or animation, effect).

Referring now to FIGS. 1(a) and 1(b), there are shown top perspective and section views, respectively, of a prior art plastic card 11 that is designed to include a lenticular device 13, this type of card being commonly referred to in the art simply as a lenticular card. In the present example, plastic card 11 is shown comprising an intermediate layer 15 that is disposed between a top layer 17 and a bottom layer 19, further information relating to layers 15, 17 and 19 to be described in detail below.

Lenticular device 13 is represented herein as a small oval-shaped element that is disposed in one corner of card 11 (e.g., for security purposes). As seen most clearly in FIG. 1(b), lenticular device 13 includes a lenticular lens structure 21 that is formed into top surface of top layer 17. Lenticular lens structure 21 includes a series, or array, of thin, raised, semi-cylindrical lenses that extend transversely across top layer 17 in a parallel relationship.

It should be noted that because the array of semi-cylindrical lenses extends parallel to the lateral axis of card 11, lenticular device 13 is referred to in the industry as having a changeable laser image, or CLI, lenticular structure. By contrast, if the array of lenses were alternatively designed to extend in parallel with the longitudinal axis of card 11, the resultant lenticular device would be referred to in the industry as having a multiple laser image, or MLI, lenticular structure.

It should also be noted that although the array of semi-cylindrical lenses is represented herein as being raised above the top surface of top layer 17, lenticular devices are also commonly constructed with an array of semi-cylindrical lenses that is embedded beneath the top surface of layer 17 (i.e., such that the apex of each lens lies flush with top surface of layer 17).

A lenticular image 23 is represented herein as being printed onto card 11 beneath lenticular lens structure 21 (i.e., sub-surface). Commonly, lenticular image 23 is printed onto card 11 upon completion of its manufacture. For example, a traditional laser may be utilized to print lenticular image 23 beneath lenticular lens structure 21, the depth of printed image 23 being regulated through modulation of the focal length and intensity of the laser.

As can be appreciated, lenticular image 23 includes multiple print images that are sliced into thin, parallel strips and, in turn, interlaced in an alternating fashion to form an image array. Due to the construction of lens structure 21, a first set of selected strips from image 23 can be viewed at a first angle and a second set of selected strips from image 23 can be viewed at a second angle. In this manner, lenticular image 23 achieves its desired multi-dimensional and/or animated effect.

Referring now to FIG. 2, transaction card 11 is typically mass-produced by fusing together one or more enlarged, separate sheets of durable plastic material, such as polyvinyl chloride (PVC), acrylonitrile butadiene styrene (ABS) or polycarbonate, to form a unitary structure. In a subsequent manufacturing step, a plurality of individual cards (typically 24-96 cards) are then stamped, punched or otherwise separated from the unitary plastic structure.

For instance, an enlarged intermediate, or filler, sheet 25 is commonly provided that is often print-receptive on at least one of its surfaces. In addition, a top transparent overlay sheet 27 and a bottom transparent overlay sheet 29 are disposed on opposing sides of sheet 25 for protective purposes. Together, sheets 25, 27, and 29 as well as any ink layers printed thereon preferably provide card 11 with an overall thickness that is in compliance with industry guidelines.

The plurality of separate sheets 25, 27 and 29 is then traditionally fused together into a single plastic card sheet 31 as part of a lamination process. An automated lamination machine, or laminator, is commonly utilized to apply heat and pressure to multiple stacks of sheets 25, 27, and 29 at the same time (i.e., to maximize production efficiency). Referring now to FIGS. 3(a) and 3(b), there is shown one well known type of lamination book, or cassette, 33 that can be disposed into a laminator in order to simultaneously laminate multiple stacks of sheets 25, 27, and 29 at a time (often as many as 6 to 10 stacks), the cassette 33 being shown upon completion of the lamination process. In other words, each stack of sheets 25, 27 and 29 is shown already fused together to form a corresponding unitary card sheet 31.

As can be seen, cassette 33 comprises a plurality of thin, very high gloss, metal lamination plates 35, with each card sheet 31 sandwiched between an opposing pair of plates 35. Together, plates 35 and sheets 31 are alternatively arranged and held firmly together as a stack by a pair of outer heated platens 37. Accordingly, it is to be understood that with cassette 33 disposed in a laminator, the heat and pressure applied to platens 37 (as represented by arrows A in FIG. 3(b)) is, in turn, transferred to metal lamination plates 35. Due to its high gloss construction, lamination plates 35 fuse together each set of sheets 25, 27, and 29 into a unitary card sheet 31 that has a high gloss appearance. Upon completion of the lamination process, each unitary card sheet 31 is manually removed from cassette 33 and, in turn, stamped to form a plurality of individual transaction cards.

To produce a transaction card 11 with a lenticular device 13, selected lamination plates 35 are provided with a plurality of lenticular patches 39, each lenticular patch 39 creating a corresponding lenticular lens structure 21 in card sheet 31 during the lamination process. Specifically, referring now to FIG. 4(a), there is shown a lamination plate 35 that includes a flat, high gloss, front surface 41 and a flat, high gloss, rear surface 43. Lamination plate 35 additionally includes a plurality of oval lenticular patches 39 that are formed into front surface 41 at specified locations. As seen most clearly in FIG. 4(b), each lenticular patch 39 includes an array of adjacent semicircular grooves 45 that extend transversely within its oval-shaped periphery in a parallel relationship.

Lamination plates of the type described above that are traditionally used to manufacture plastic cards that include a lenticular device have been found to suffer from a couple notable drawbacks.

As a first drawback, it is to be understood that each lenticular patch 39 in lamination plate 35 is typically formed through a time-consuming laser engraving, or etching, process (due to the sensitive nature of high gloss front surface 41). As a consequence, it is to be understood that the cost associated with an etched lamination plate (e.g., of the type shown in FIG. 4(a)) is considerably more expensive than the cost associated with a non-etched plate (often 30 times more expensive). Furthermore, because each lamination cassette 33 that is used to mass-produce lenticular-type plastic cards requires a considerable number of etched lamination plates, the overall cost associated with producing lenticular cards is often found to be prohibitively excessive, which is highly undesirable.

As a second drawback, it is to be understood that the intricate nature of each lenticular patch 39 in lamination plate 35 must be maintained in order to produce a plastic card with a properly functioning lenticular device. If a single lenticular patch 39 is either improperly formed during its initial manufacture or damaged subsequently during routine use, the entire lamination plate 35 is typically discarded, which is highly undesirable.

### BRIEF SUMMARY OF THE INVENTION

It is an object of the present invention to provide a new and improved lamination plate for use in manufacturing a plastic card with a lenticular device.

It is another object of the present invention to provide a lamination plate of the type as described above that includes one or more lenticular patches, each lenticular patch creating a corresponding lens structure in a card sheet produced during lamination.

It is yet another object of the present invention to provide a lamination plate of the type as described above that is inexpensive to manufacture, has a limited number of parts, and is easy to use.

It is yet still another object of the present invention to provide a lamination plate of the type as described above that enables damaged lenticular patches in the lamination plate to be easily repaired.

Accordingly, as a principal feature of the present invention, there is provided a lamination plate assembly, comprising (a) a first lamination plate comprising first and second opposing surfaces, the first lamination plate being shaped to define one or more bores that extend at least partially into the first surface, and (b) one or more inserts, each of the one or more inserts being dimensioned for insertion into a corresponding bore in the first lamination plate, each insert having a first surface and a second surface, wherein the first surface of each of the plurality of inserts is shaped to include a lenticular lens structure.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1(a) is a top perspective view of a plastic card with a lenticular device;

FIG. 1(b) is an enlarged, fragmentary, section view of the plastic card shown in FIG. 1(a), taken along lines 1B-1B;

FIG. 2 is a top exploded perspective view of an enlarged plastic card sheet that is used to construct one or more plastic cards of the type shown in FIG. 1;

FIG. 3(a) is a top perspective view of a lamination cassette that is used in the art to constructed one or more plastic cards of the type shown in FIG. 1;

FIG. 3(b) is a top section view of the lamination cassette shown in FIG. 3(a), taken along lines 3B-3B;

FIG. 4(a) is a front perspective view of one of the lamination plates from the lamination cassette shown in FIG. 3(a);

FIG. 4(b) is an enlarged, fragmentary section view of the lamination plate shown in FIG. 4(a), taken along lines 4B-4B;

FIG. 5 is an exploded, front perspective view of a lamination plate assembly constructed according to the teachings of the present invention;

FIG. 6 is an enlarged, fragmentary, exploded, front perspective view of the front lamination plate and one of the lenticular inserts shown in FIG. 5;

FIG. 7 is an enlarged, fragmentary, assembled section view of the front lamination plate and lenticular insert shown in FIG. 6;

FIG. 8 is a top section view of a lamination cassette that utilizes multiple lamination plate assemblies of the type shown FIG. 5 to construct a plurality of plastic cards of the type shown in FIG. 1; and

FIG. 9 is an enlarged, fragmentary, assembled section view of a design modification to the front lamination plate and lenticular insert shown in FIG. 7.

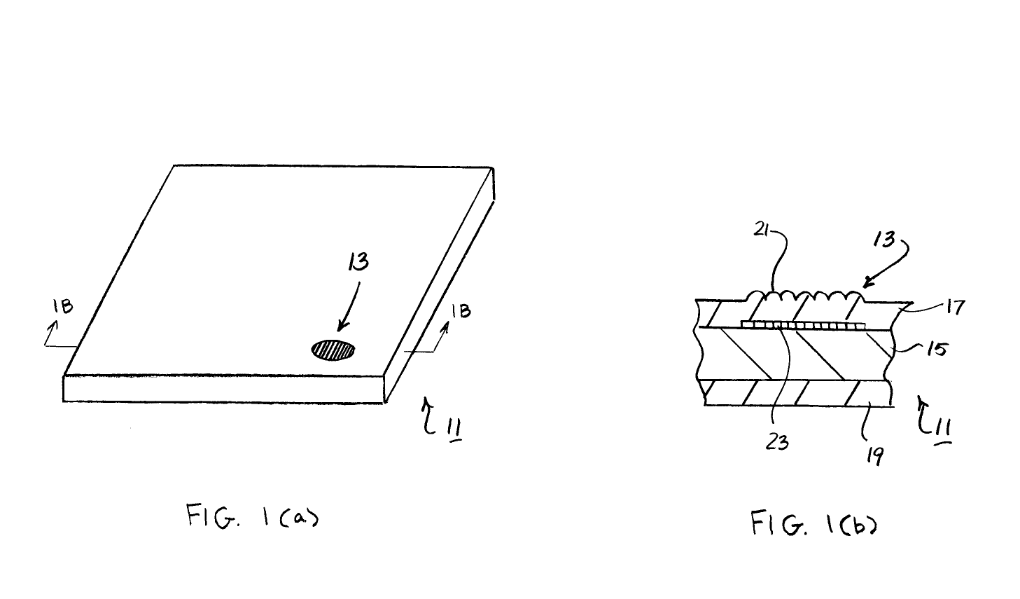

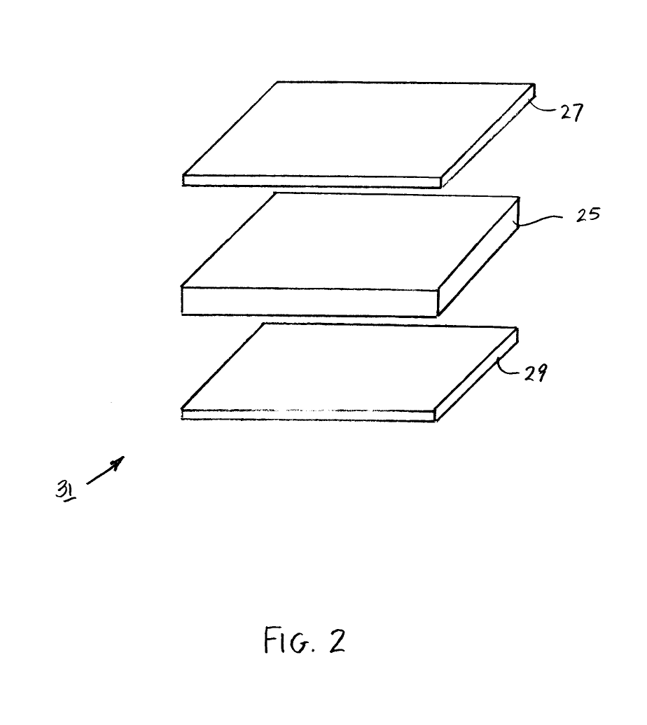

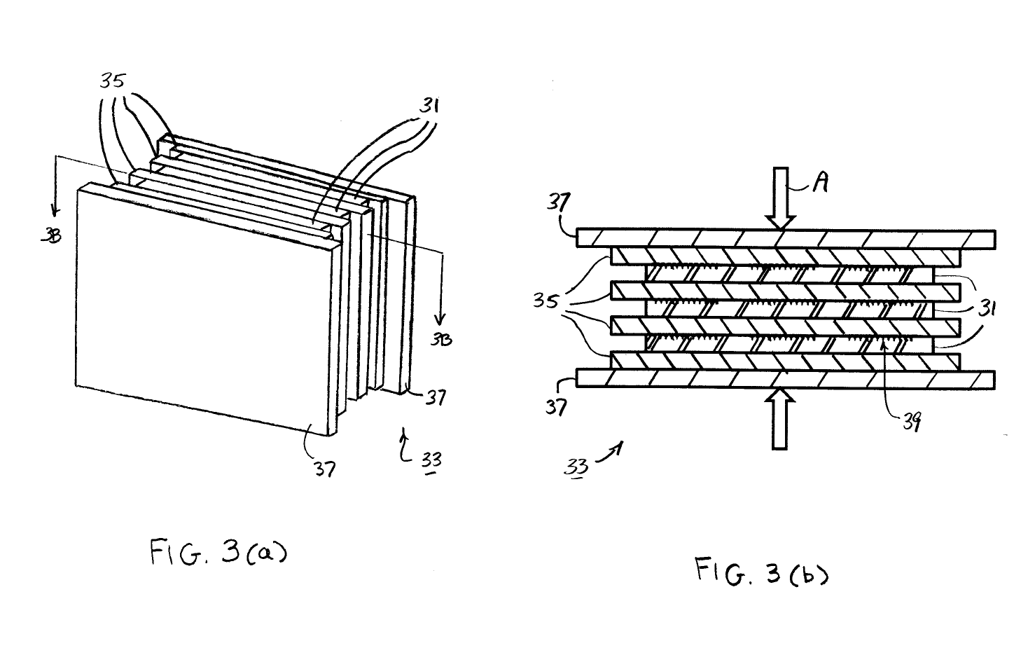

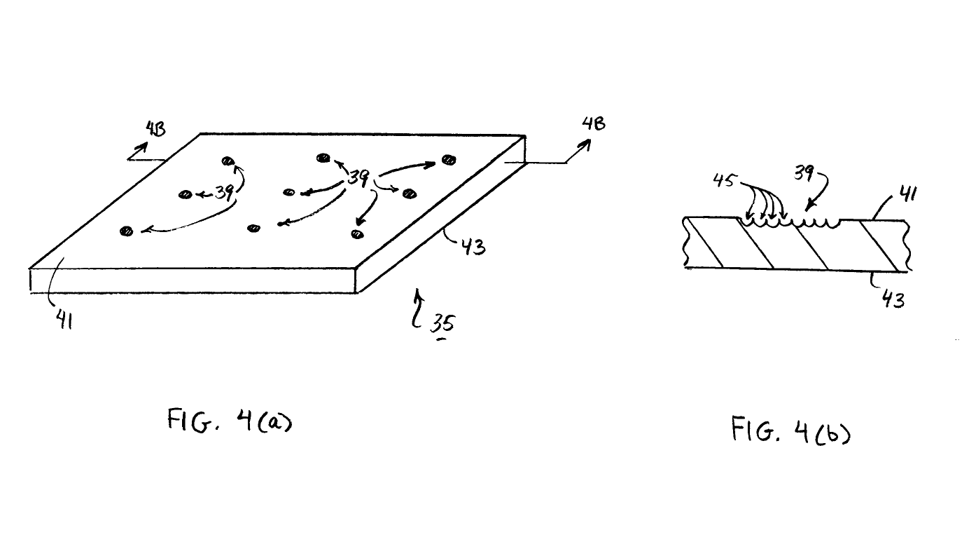

### DETAILED DESCRIPTION OF THE INVENTION

### Lamination Plate Assembly 111

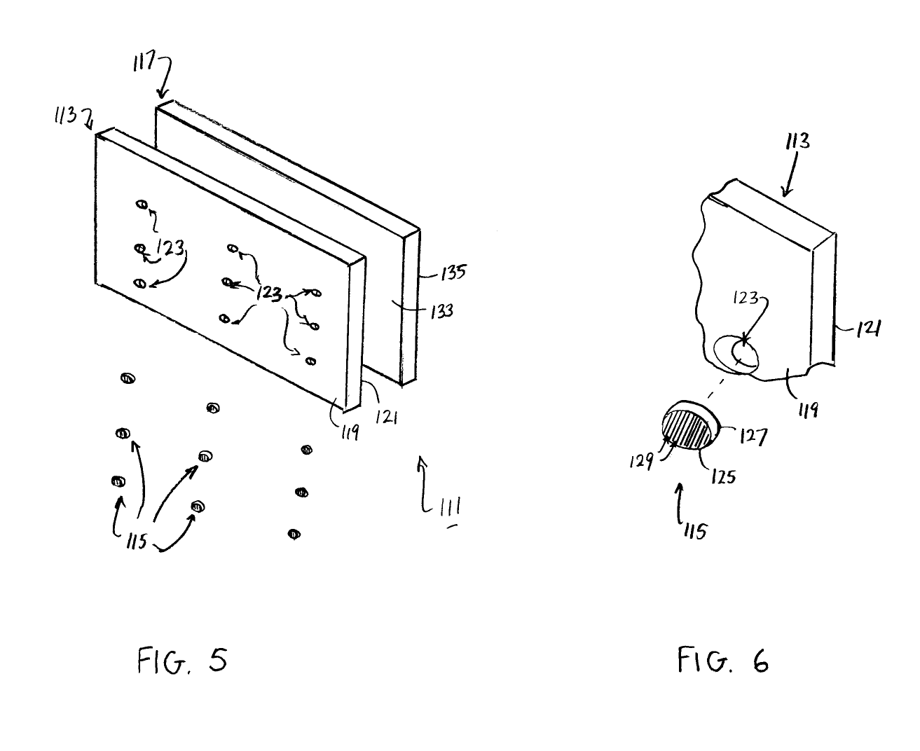

Referring now to FIG. 5, there is shown a lamination plate assembly that is constructed according to the teachings of the present invention, the lamination plate assembly being identified generally by reference numeral 111. As will be described in detail below, lamination plate assembly 111 is designed primarily for use in the manufacture of plastic cards 11 that include a lenticular device 13.

Lamination plate assembly 111 includes a front lamination plate 113, a plurality of insertable lenticular patches, or inserts, 115 fittingly disposed into front lamination plate 113, and an optional back lamination plate 117 disposed against the rear surface of front lamination plate 113. As will be described further below, lamination plate assembly 111 is designed for use within a low-cost lamination cassette that can fed into a lamination machine to produce at least one enlarged card sheet 31 from which can be separated a plurality of individual lenticular-type plastic cards 11.

Front lamination plate 113 is preferably constructed as enlarged, generally rectangular plate that includes a smooth, high gloss, and flat front surface 119 and a smooth, high gloss, and flat rear surface 121. Preferably, lamination plate 113 is constructed out of any rigid, durable and thermally conductive material, such as metal.

A plurality of oval bores 123 is formed into lamination plate 113, each bore 123 extending transversely through the entirety of plate 113 from front planar surface 119 to rear planar surface 121, as seen most clearly in FIG. 6. Bores 123 are preferably formed into lamination plate 113 using any relatively inexpensive bore forming process. For instance, bores 123 may be formed into lamination plate 113 through a machine stamping process. In the present example, nine separate bores 123 are arranged in plate 113 within a grid of three equidistantly-spaced columns and three equidistantly-spaced rows, for reasons to become apparent below.

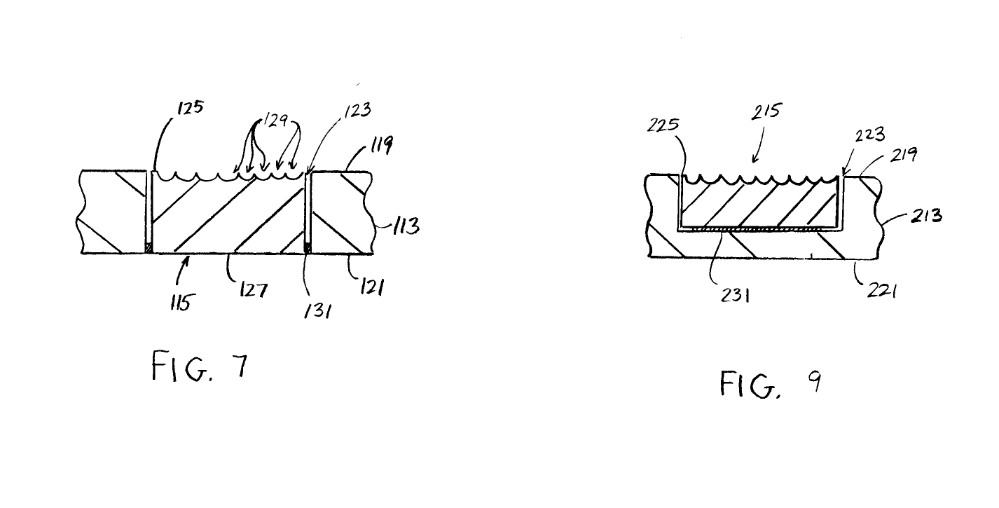

As referenced briefly above, lamination plate assembly 111 includes a plurality of lenticular inserts 115, each insert 115 being dimensioned for fitted insertion within a corresponding bore 123 in front lamination plate 113. Each lenticular insert 115 is preferably in the form of an oval, metal disc that includes a front surface 125 and a rear surface 127. As seen most clearly in FIGS. 6 and 7, front surface 125 is textured, or shaped, to include an array of adjacent, semicircular, lateral grooves 129 that extend in a parallel relationship.

Although represented herein as inlayed, or subsurface, grooves 129, it is to be understood that grooves 129 could alternatively be raised (i.e., above front surface 125) without departing from the spirit of the present invention. Furthermore, although grooves 129 are represented herein as extending laterally, or transversely, across front surface 125, it is to be understood that grooves 129 could extend longitudinally (i.e., parallel to its longitudinal axis) without departing from the spirit of the present invention.

Preferably, inserts 115 are mass-produced as part of a designated manufacturing process. For instance, a press tool with a hardened die that is engraved with the particular pattern that compliments grooves 129 could be used to (i) punch out an oval shaped disc from a metal sheet and (ii) simultaneously stamp its front surface with the particular MLI/CLI lenticular lens structure (i.e., the aforementioned pattern of grooves 129). In this manner, a supply of lenticular inserts 115 could be mass-produced in a relatively inexpensive fashion.

It should be noted that inserts 115 need not be provided with its lenticular lens structure using the aforementioned stamping process. Rather, it is to be understood that alternative, cost-effective means for forming the lenticular lens structure into each insert 115 could be readily accomplished (e.g., through machine grinding, milling, ablating or the like) without departing from the spirit of the present invention.

As seen most clearly in FIG. 7, each insert 115 is preferably fittingly disposed within a corresponding bore 123 in lamination plate 113, with rear surface 127 of insert 115 lying generally flush with rear surface 121 of plate 113 and front surface 125 of insert 115 lying co-planar with front surface 119 of plate 113. Insert 115 is permanently retained within bore 123 by securing at least a portion of the periphery of rear surface 127 of insert 115 to rear surface 121 of plate 113 using at least one bonding agent 131, such as an adhesive, solder, or other suitable securement means.

It is important to note that each insert 115 is permanently secured to lamination plate 113 about rear surface 127. As a result, the high gloss, front surface 119 of lamination plate 113 remains in its pristine form and thereby avoids being subjected to potentially harmful scratches or other similar damage.

At the same time, it should be noted that surface imperfections may be created in rear surface 121 of lamination plate 113 during the process of securing each insert 115 within its corresponding bore 123. The introduction of these surface imperfections in rear surface 121 of lamination plate 113 would, in turn, create similar imperfections in a card sheet 31 that is disposed in direct contact therewith.

Accordingly, an optional back plate 117 can be utilized to resolve, or smooth-out, surface imperfections created in rear surface 121 of lamination plate 113, as can be seen in FIG. 5. Similar to front lamination plate 113, back lamination plate 117 is preferably constructed as enlarged, generally rectangular plate that includes a smooth, high gloss, and flat front surface 133 and a smooth, high gloss, and flat rear surface 135, plate 117 being constructed out of any rigid, durable and thermally conductive material, such as metal.

Back plate 117 differs from front plate 113 in that back plate 117 is an entirely solid member that does not include complimentary bores 123 and inserts 115. Accordingly, by disposing front planar surface 133 of back plate 117 directly against rear planar surface 121 of front lamination plate 113, any surface imperfections in rear surface 121 are effectively covered by back plate 117. In this capacity, it is to be understood that pristine rear surface 135 of back plate 117 serves as the contact lamination surface in place of non-pristine rear surface 121 of front plate 113.

### Mass-Production of Lenticular Cards 11 using Lamination Plate Assemblies 111

Referring now to FIG. 8, there is shown a lamination cassette 137 that utilizes selected components from several lamination plate assemblies 111 to form multiple, enlarged card sheets 31 from which can be separated a plurality of individual lenticular-style cards 11. Specifically, in the present example, three separate card sheets 31-1, 31-2 and 31-3 are shown. First card sheet 31-1 is sandwiched between rear surface 135-1 of a first back lamination plate 117-1 and front surface 119-1 of a first front lamination plate 113-1. Second card sheet 31-2 is sandwiched between rear surface 135-2 of a second back lamination plate 117-2, which is disposed directly against rear surface 121-1 of first front lamination plate 113-1, and front surface 119-2 of a second front lamination plate 113-2. Third card sheet 31-3 is sandwiched between rear surface 135-3 of a third back lamination plate 117-3, which is disposed directly against rear surface 121-2 of second front lamination plate 113-2, and front surface 119-3 of a third front lamination plate 113-3. Lamination cassette 131 additionally includes a pair of heated outer platens 139-1 and 139-1, with first platen 139-1 disposed against front surface 133-1 of first back lamination plate 117-1 and second platen 139-2 disposed against rear surface 121-3 of third front lamination plate 113-3.

It is to be understood that with cassette 137 loaded into a lamination machine, the heat and pressure applied to outer platens 139 (as represented by arrows B) is, in turn, transferred to each of lamination plates 113 and 117. As such, each card sheet 31 disposed within cassette 137 is fused as a unitary member from its original separate plastic layers (e.g., sheets 25, 27 and 29). As referenced above, the inclusion of back plates 117-2 and 117-3 prevents surface defects that are created in the rear of front plates 113-1 and 113-2, respectively, during the process of permanently securing inserts 115 thereto from marring or otherwise damaging the opposing face of the adjacent card sheet 31.

The inclusion of inserts 115 in each lamination plate 113 creates a pattern of lenticular lens structures 21 in the opposing face of the card sheet 31 in direct contact thereagainst. As a result, upon completion of the lamination process, lamination cassette 133 is removed from the lamination machine. Each card sheet 31 is then withdrawn from lamination cassette 133, with nine lenticular lens structures 21 formed in one surface of each card sheet 31 in the defined pattern, or grid, which corresponds to the arrangement of inserts 115 in lamination plate 113.

The resultant card sheet 31 can then be stamped to create nine separate plastic cards 11, each card 11 being provided with an oval-shaped lenticular lens structure 21 in a common location. In a subsequent step, lenticular image 23 is preferably printed on each card 11 (e.g., beneath each lenticular lens structure 21 using a sub-surface laser printing device) to create a lenticular device 13, which is a principal object of the present invention.

### Additional Embodiments and Design Modifications

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

For example, in the present example, each card sheet 31 produced from cassette 137 includes nine, separate, oval-shaped, lenticular lens structures 21 in its front surface. However, it should be noted that the number, shape and arrangement of inserts 115 in lamination plate 113 (and, as a result, the number, shape and arrangement of lens structures 21 in each card sheet 31 produced therefrom) could be modified without departing from the spirit of the present invention. In particular, it is to be understood that the number of inserts 115 disposed within lamination plate 113 could be increased (e.g., to 24 or 96 inserts per plate) to increase the productivity and overall efficiency of the card manufacturing process.

As another example, it should be noted that inserts 115 are not limited for use with a particular type or style of lamination plate 113. Rather, it is to be understood that inserts 115 could be secured to modified lamination plates in alternative arrangements, or patterns, without departing from the spirit of the present invention in order to create a wide variety of lenticular card styles. In this manner, the particular location of the lenticular lens structure in a plastic card could be modified by simply forming each insert-receiving bore in a different position within a new lamination plate. By contrast, the traditional method for modifying the location a lenticular lens structure within a plastic card requires that an entirely new set of laser-etched lamination plates be manufactured, which is considerably expensive.

As another example, it should be noted that lamination cassette 137 is not limited to particular number and arrangement of front and back lamination plates 113 and 117 represented herein. Rather, it is to be understood that additional front and back lamination plates 113 and 117 could be incorporated into cassette 133 in a similar arrangement to allow for the simultaneous lamination of additional card sheets 31 (e.g., to produce as many as 6 to 10 card sheets from each lamination cassette).

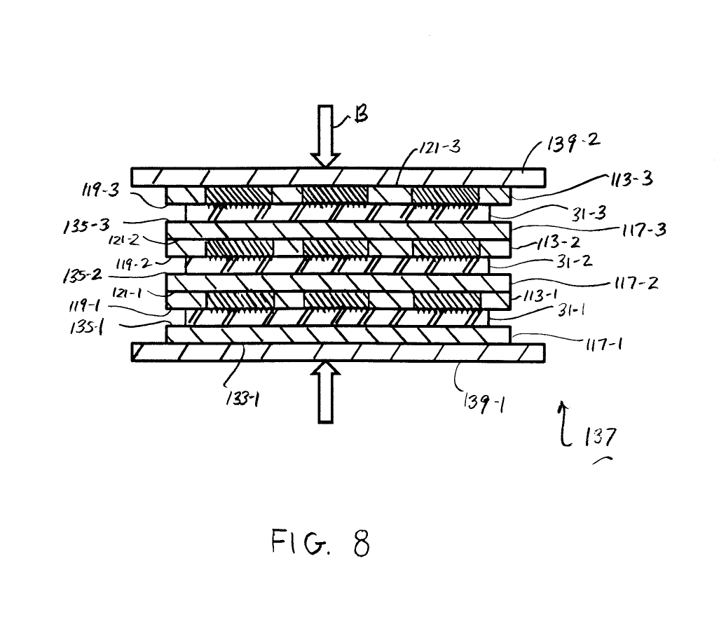

As another example, it should be noted that each bore 123 need not extend transversely through the entirety of front lamination plate 113. Specifically, referring now to FIG. 9, there is shown an enlarged, fragmentary, section view of a design modification to the lamination plate 113 and lenticular insert 115 shown in FIG. 7.

As can be seen, a modified lamination plate 213 is provided that includes a flat front surface 219 and a flat rear surface 221. A bore, or cavity, 223 is partially routed, or otherwise formed, into front surface 219. In turn, a lenticular insert 215 is fittingly disposed within bore 223 in lamination plate 213 and is secured thereto using a bonding agent 231, such as such an adhesive, solder, or other suitable securement means. As can be appreciated, inserts 215 differ from inserts 115 primarily in that each insert 215 is reduced in its thickness to the extent that its front surface 225 lies substantially flush with front surface 219 of lamination plate 213. Furthermore, it is to be understood that by only partially routing bore 223 into lamination plate 213, rear surface 221 of lamination plate 213 is not disturbed, thereby eliminating the need for a corresponding back plate 117.

What is claimed is:

1. A lamination plate assembly, comprising:
(a) a first lamination plate comprising first and second opposing surfaces, the first lamination plate being shaped to define one or more bores that extend at least partially into the first surface; and
(b) one or more inserts, each of the one or more inserts being dimensioned for insertion into a corresponding bore in the first lamination plate, each insert having a first surface and a second surface, wherein the first surface of each of the plurality of inserts is shaped to include a lenticular lens structure.

2. The lamination plate assembly as claimed in claim 1 further comprising a second lamination plate with first and second opposing surfaces.

3. The lamination plate assembly as claimed in claim 2 wherein the second lamination plate is entirely devoid of bores.

4. The lamination plate assembly as claimed in claim 3 wherein each of the first and second opposing surfaces of the first lamination plate is planar.

5. The lamination plate assembly as claimed in claim 4 wherein each of the first and second opposing surfaces of the second lamination plate is planar.

6. The lamination plate assembly as claimed in claim 5 wherein the first lamination plate and the second lamination plate are stacked in a parallel relationship.

7. The lamination plate assembly as claimed in claim 6 wherein the first surface of the second lamination plate faces the second surface of the first lamination plate.

8. The lamination plate assembly as claimed in claim 7 wherein the first surface of the second lamination plate directly contacts the second surface of the first lamination plate.

9. The lamination plate assembly as claimed in claim 8 wherein the second surface of the second lamination plate is entirely devoid of bores.

10. The lamination plate assembly as claimed in claim 9 wherein each of the first lamination plate, the second lamination plate and the one or more inserts is constructed out of metal.

11. The lamination plate assembly as claimed in claim 1 wherein the first surface of each of the plurality of inserts lies flush with the first surface of the first lamination plate.

12. The lamination plate assembly as claimed in claim 11 wherein the lenticular lens structure in each of the one or more inserts includes an array of adjacent, parallel grooves in the first surface.

13. The lamination plate assembly as claimed in claim 1 wherein each of the one or more bores extends transversely through the entirety of the first lamination plate from the first surface to the second surface.

14. The lamination plate assembly as claimed in claim 13 wherein each of the one or more bores extends only partially in from the first surface of the first lamination plate.

15. The lamination plate assembly as claimed in claim 1 wherein a plurality of bores extends at least partially into the first surface of the first lamination plate.

16. The lamination plate assembly as claimed in claim 15 wherein the plurality of bores is arranged in a grid of equidistantly-spaced columns and equidistantly-spaced rows.

17. The lamination plate assembly as claimed in claim 1 wherein each of the one or more inserts is dimensioned for fitted insertion into a corresponding bore in the lamination plate.

18. The lamination plate assembly as claimed in claim 17 wherein each of the one or more inserts is retained within a corresponding bore in the lamination plate by a bonding agent.

19. The lamination plate assembly as claimed in claim 18 wherein the bonding agent is an adhesive.

20. The lamination plate assembly as claimed in claim 18 wherein the bonding agent is solder.
